(19) United States
(12) Patent Application Publication
(10) Pub. No.: US 2025/0020180 A1
(43) Pub. Date: Jan. 16, 2025

(54) BRAKE TEMPERATURE DETECTOR

(71) Applicant: JHIH-HUA ZENG, TAICHUNG CITY (TW)

(72) Inventor: JHIH-HUA ZENG, TAICHUNG CITY (TW)

(21) Appl. No.: 18/675,402

(22) Filed: May 28, 2024

(30) Foreign Application Priority Data
Jul. 13, 2023 (TW) 112126241

(51) Int. Cl. F16D 66/00; B60K 35/21; B60K 35/28; B60T 17/22; G01K 1/024

(52) U.S. Cl. CPC F16D 66/00; B60K 35/21; B60K 35/28; B60T 17/22; G01K 1/024; B60K 2360/16; F16D 2066/001

(57) ABSTRACT

A brake temperature detector including a display unit, at least one signal transmitter, and a plurality temperature sensing modules is provided. The temperature sensing modules are mounted in a brake system of vehicles correspondingly and each of the temperature sensing modules includes a temperature sensor wire and a connector disposed on an end part of the temperature sensor wire. Temperature changes caused by high speed friction in the brake system sensed by the connector are transmitted to the signal transmitter and sensed results are shown on the display unit. Thereby drivers can learn working temperature and data of the brake system. By temperature monitoring, brake overheating which leads to brake failure can be avoided. Moreover, problems of the brake system (such as brake disc, brake caliper, or lining) can be found earlier by temperature difference to ensure driving safety.

### BACKGROUND OF THE INVENTION

### Field of the Invention

The present invention relates to a brake temperature detector, especially to a brake temperature detector which is able to detect brake temperature of a vehicle brake system, transmit the brake temperature, and display the brake temperature.

### Description of Related Art

Along with fast development of technology, vehicle power is increased fast and speed performance is getting high. Thus transportation efficiency is improved dramatically. At the same time, a brake system with high clamping force is required to maintain driving safety.

In a brake system of vehicles, resistance generated by friction between brake pads and a brake disc or a brake drum is used to reduce speed of the vehicle or stop the vehicle. However, in order to stop in a short period of time during high-speed movement, the friction between the brake pads and the brake disc or the brake drum is considerably high and high heat is created due to the friction. The high heat raises temperature of the brake pads to a high level. The high temperature of the brake pads decreases friction coefficient of the brake pads and further affects its performance.

Moreover, excessive heat of the brake pads makes brake fluid experience evaporation, which reduces braking power. Thus brake failure may occur and further results in serious traffic accidents. Since the brake system is critical to life safety of drivers, there is room for improvement and there is a need to provide a novel brake system.

### SUMMARY OF THE INVENTION

Therefore, it is a primary object of the present invention to provide a brake temperature detector which is able to detect brake temperature of a vehicle brake system, transmit the brake temperature, and display the brake temperature.

In order to achieve the above object, a brake temperature detector according to the present invention includes a display unit, at least one signal transmitter, and a plurality temperature sensing modules. The temperature sensing modules are mounted in a brake system of vehicles correspondingly and each of the temperature sensing modules consists of a temperature sensor wire and a connector disposed on an end part of the temperature sensor wire. Temperature changes caused by high speed friction in the brake system and sensed by the connector are transmitted to the signal transmitter and sensed results are shown on the display unit. Thereby drivers can learn working temperature and data of the brake system. By temperature monitoring, brake overheating which leads to brake failure can be avoided. Moreover, problems of the brake system (such as brake disc, brake caliper, or lining) can be found earlier by temperature difference and this helps to ensure driving safety.

Preferably, the signal transmitter is connected to the temperature sensor wire for receiving the brake temperature from the temperature sensor wire and transmitting the brake temperature to the display unit in a wireless way.

Preferably, the signal transmitter is provided with a power supply unit which provides power required to the signal transmitter.

Preferably, the display unit is used to show values of the brake temperature detected by the plurality of the temperature sensing modules and provided with warning lights and an alarm unit to remind drivers.

Preferably, the connector on the end part of the temperature sensor wire is provided with a ring portion which is fitted on a threaded part of a brake shoe corresponding.

Preferably, the connector on the end part of the temperature sensor wire is provided with a U-shaped portion which is mounted and inserted into a threaded part of a brake shoe.

Preferably, the connector on the end part of the temperature sensor wire is provided with a mounting base and a sensing piece. One end of the mounting base is connected to the temperature sensor wire correspondingly while the other end of the mounting base is inserted by and contacted with the sensing piece. The sensing piece is fixed between the lining and a back board.

Preferably, the connector on the end part of the temperature sensor wire is provided with a mounting base and a clip. One end of the mounting base is connected to the temperature sensor wire correspondingly while the other end of the mounting base is inserted by and contacted with the clip. The clip is clipped and fixed on a shaft used for connecting a back board having the lining with the brake caliper. The clip is a C-shaped clip.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded view of an embodiment according to the present invention;

FIG. 2 is a schematic drawing showing a display unit and a signal transmitter of an embodiment according to the present invention;

FIG. 3 is a top view of an embodiment according to the present invention;

FIG. 4 is an exploded view of another embodiment according to the present invention;

FIG. 5 is a top view of another embodiment according to the present invention;

FIG. 6 is an exploded view of a further embodiment according to the present invention;

FIG. 7 is a schematic drawing showing movement of a further embodiment according to the present invention;

FIG. 8 is a sectional view of a further embodiment according to the present invention;

FIG. 9 is an exploded view of a fourth embodiment according to the present invention;

FIG. 10 is a schematic drawing showing movement of a fourth embodiment according to the present invention;

FIG. 11 is a sectional view of a fourth embodiment according to the present invention;

FIG. 12 is a schematic drawing showing brake temperatures shown on a display unit of an embodiment according to the present invention.

### DETAILED DESCRIPTION OF THE PREFERRED EMBODIMENT

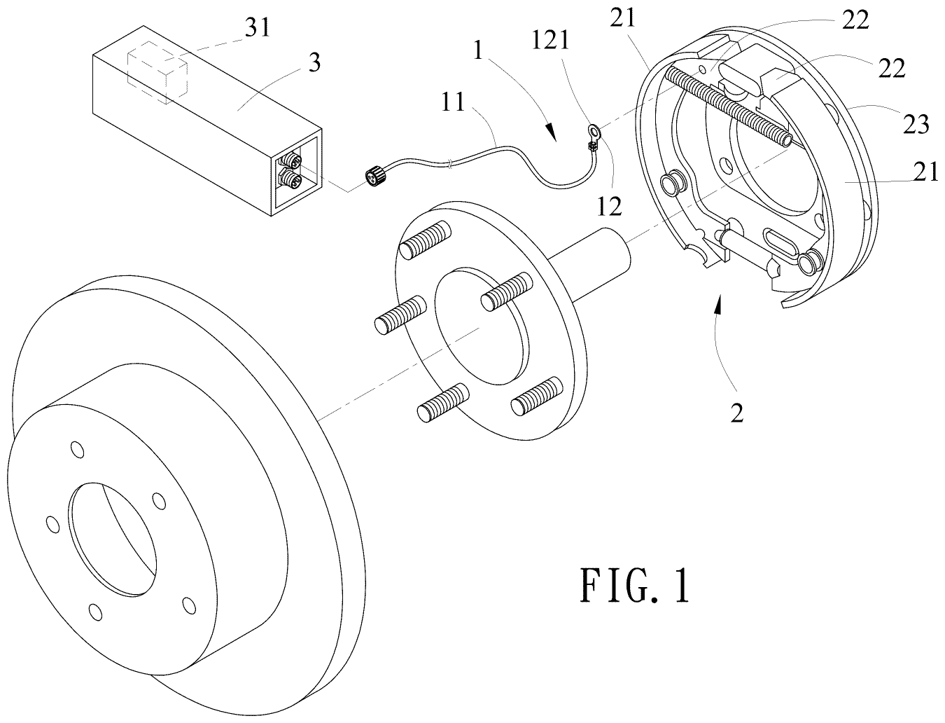

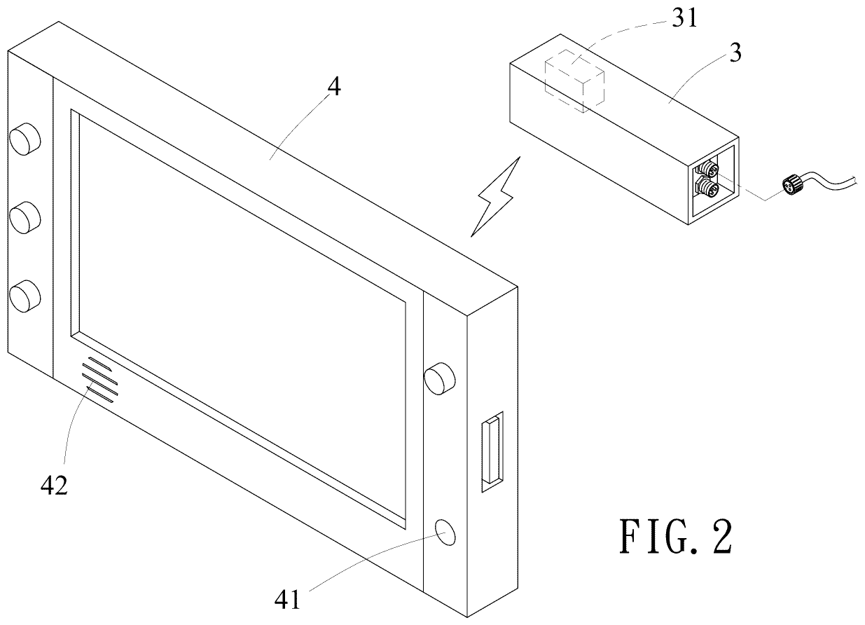

Refer to FIGS. 1-2, FIG. 4, FIG. 6, and FIG. 9, a brake temperature detector according to the present invention mainly includes a plurality temperature sensing modules 1, at least one signal transmitter 3, and a display unit 4.

Each of the temperature sensing module 1 is composed of a temperature sensor wire 11 and a connector 12 which is connected to an end part of the temperature sensor wire 11 correspondingly and mounted in a brake system 2 of vehicles for sending brake temperature of the braking system 2 through the temperature sensor wire 11.

The signal transmitter 3 is connected with the temperature sensor wire 11 correspondingly for accepting the brake temperatures detected by the temperature sensing modules 1 and transmitting brake temperature signals in a wireless way.

The display unit 4 receives the brake temperature signals from the signal transmitter 3 wirelessly and shows values of the brake temperatures detected by the temperature sensing modules 1.

There are two types of a brake system 2 for vehicles in use: drum brakes and disc brakes. The drum brake consists of brake shoes 22 which are provided with brake linings 21 and pivotally mounted to a brake rotor 23. During braking, the brake shoes 22 are moved outward and pressed against brake drums to generate friction for offering superior braking force. As to the disc brake system, it is composed of a brake disc 24, a brake caliper 25, linings 21, and brake fluid. The brake disc 24 is rotated along with wheels and used for converting kinetic energy into thermal energy to stop the wheels. The brake caliper 25 is a component attached and mounted to a front or a rear side of the brake disc 23. The lining 21 is a wear resistant part in contact with the brake disc 24. The lining 21 is connected to a back board 26 and mounted in the brake caliper 25 by a shaft 27 inserted through the back board 26. The brake caliper 25 is provided with at least one internal piston used for pressing against the lining 21. When drivers step on brake pedals, the brake fluid is pressurized and forced to move the piston so that the lining 21 comes in contact with the brake disc 24 to slow down the vehicle and generate heat.

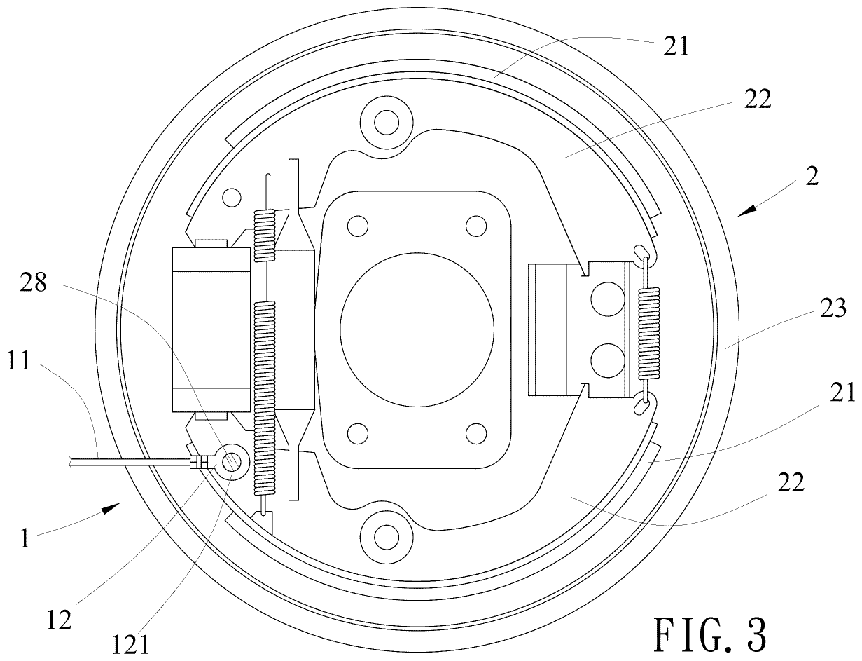

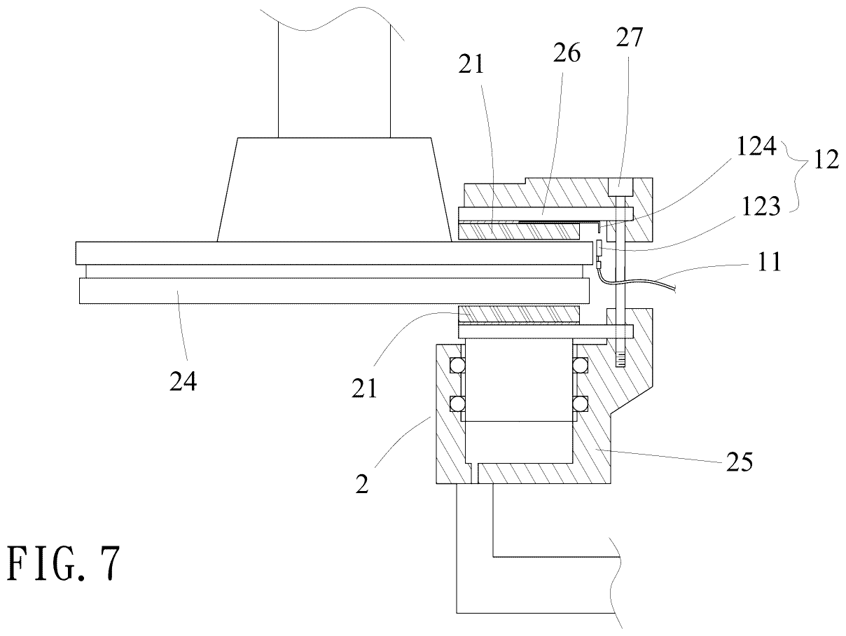

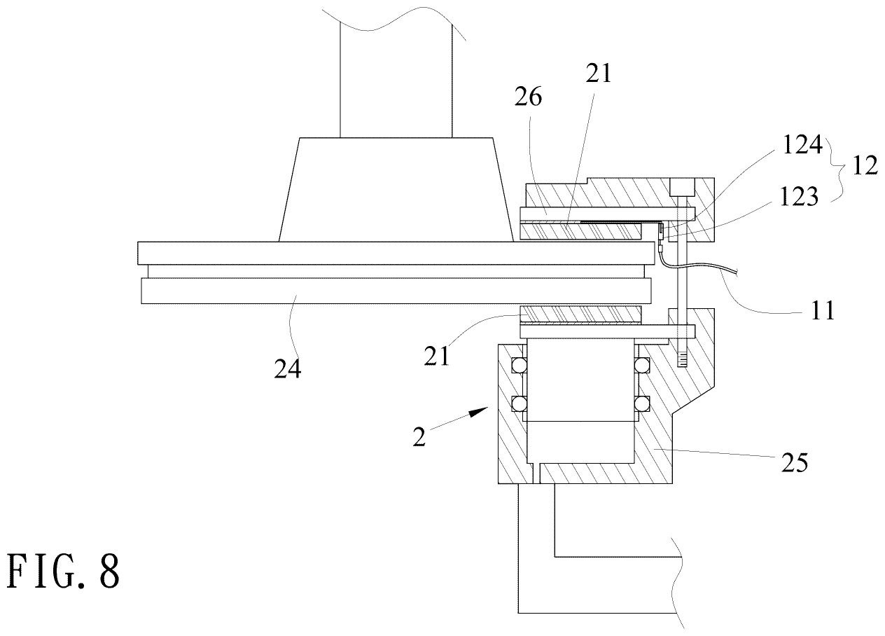

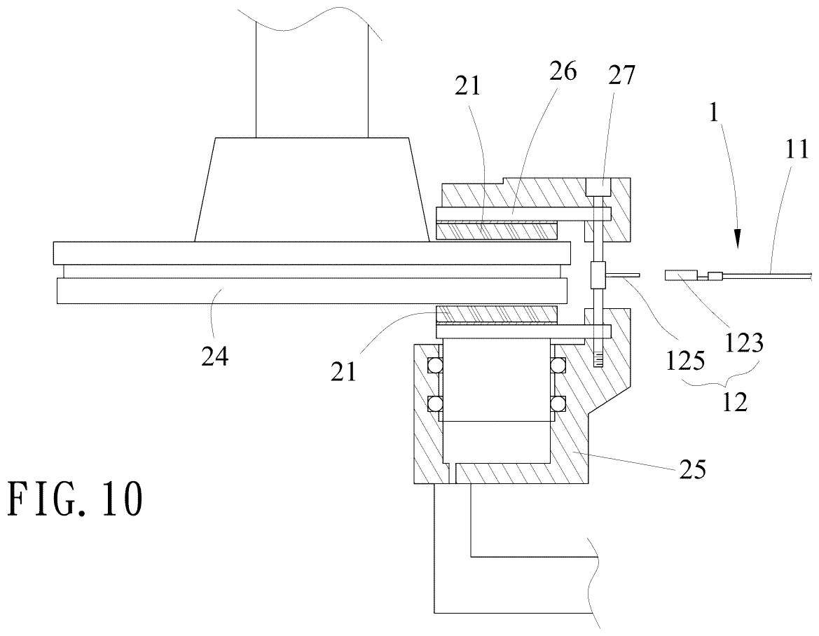

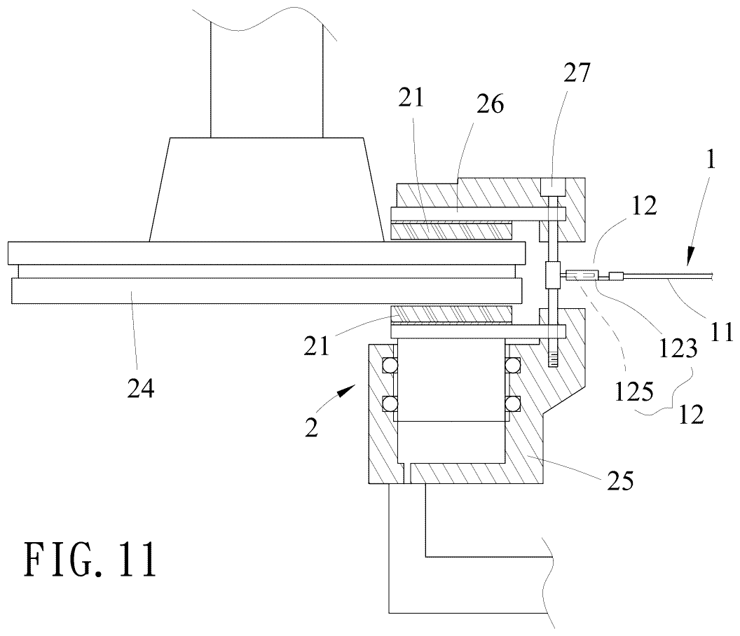

As shown in FIGS. 1-12, while in use, there are several types of the brake systems 2 and the connectors 12 in different embodiments of the present invention. Each of the four wheels of the vehicle is connected with the temperature sensing module 1 correspondingly and each of the temperature sensing modules 1 has a corresponding signal transmitter 3. The details are as follows.

### Embodiment One

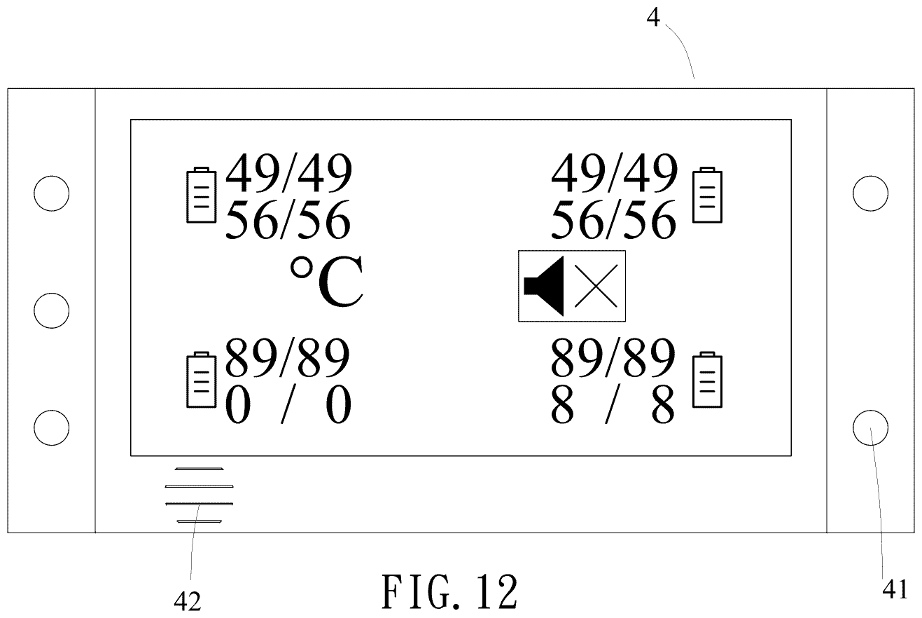

Refer to the first embodiment shown in FIGS. 1-3, the present brake temperature detector is applied to the drum brake system 2. The connector 12 on the end part of the temperature sensor wire 11 is provided with a ring portion 121 which is fitted on a threaded part 28 of the brake shoe 22 to be installed and fastened together with the brake shoe 22 while mounting the brake shoe 22. When the brake system 2 works, a temperature of the lining 21 on the brake shoe 22 generated due to friction is sent to the ring portion 121 of the connector 12 and the brake temperature signals are sent to the signal transmitter 3 through the temperature sensor wire 11. Each of the signal transmitters 3 gets power from a built-in power supply unit 31 which is a rechargeable battery and then transmits the brake temperature signals to the display unit 4 in a wireless manner. Then values of the brake temperature and power status detected by the plurality of the temperature sensing modules 1 are shown on the display unit 4, as shown in FIG. 12. The display unit 4 consists of a warning light 41 for generating warning light signals and an alarm unit 42 for creating warning sounds. When the brake temperature is too high (over a set value) or abnormal, drivers are reminded about the brake temperature by the warning light 41 and the alarm unit 42 to ensure driving safety.

### Embodiment Two

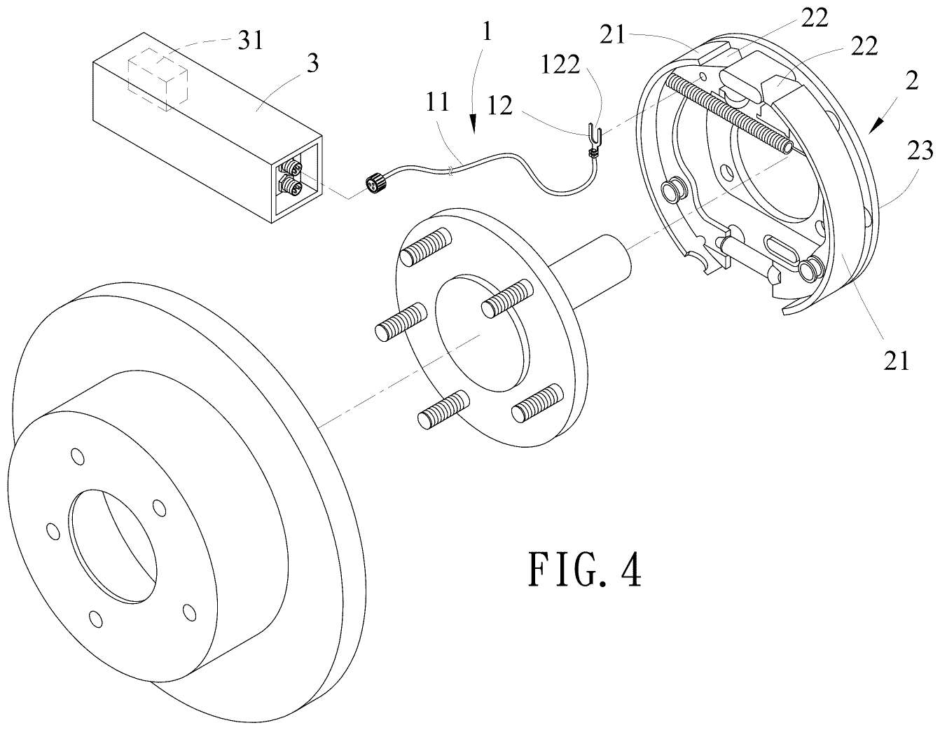

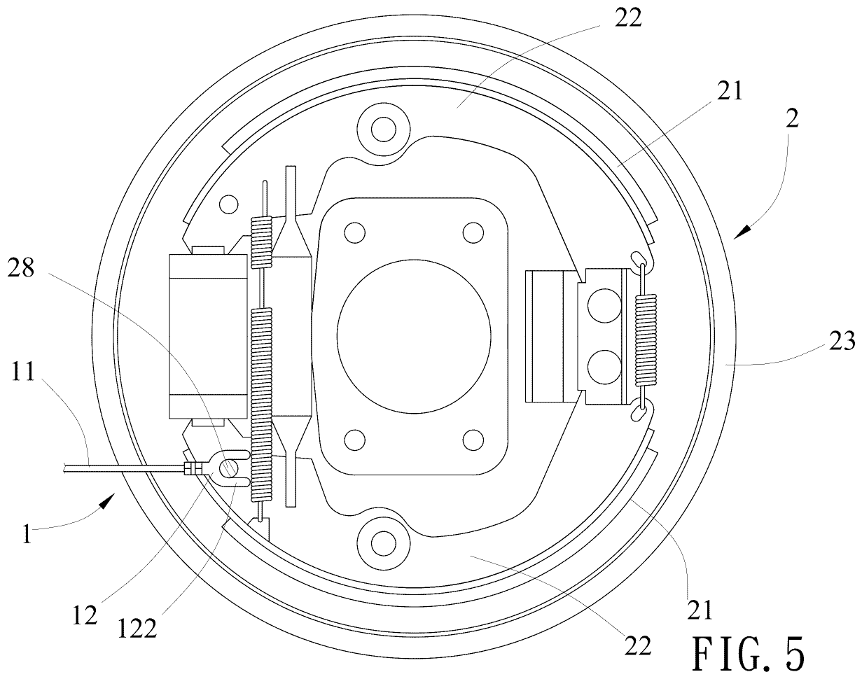

Refer to the second embodiment shown in FIGS. 4-5, the present brake temperature detector is applied to the drum brake system 2. The connector 12 on the end part of the temperature sensor wire 11 is provided with a U-shaped portion 122 which is mounted to and inserted in a threaded part 28 of the brake shoe 22 to be installed and fastened together with the brake shoe 22 during installation of the brake shoe 22. When the brake system 2 works, a temperature of the lining 21 on the brake shoe 22 generated due to friction is sent to the U-shaped portion 122 of the connector 12 and the brake temperature signals are transmitted to the signal transmitter 3 through the temperature sensor wire 11. Each of the signal transmitters 3 gets power from a built-in power supply unit 31 which is a rechargeable battery and then sends the brake temperature signals to the display unit 4 wirelessly. Then values of the brake temperature and power status sensed by the plurality of the temperature sensing modules 1 are shown on the display unit 4, as shown in FIG. 12. The display unit 4 is composed of a warning light 41 for generating warning light signals and an alarm unit 42 for creating warning sounds. When the brake temperature is too high (over a set value) or abnormal, drivers are reminded about the brake temperature by the warning light 41 and the alarm unit 42 to ensure driving safety.

### Embodiment 3

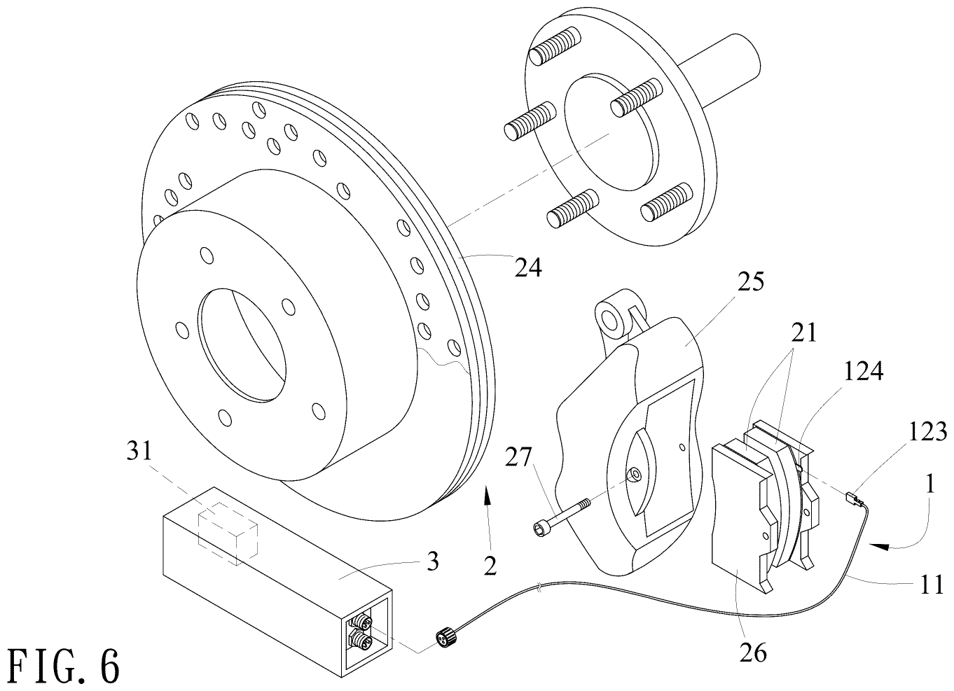

Refer to the third embodiment shown in FIGS. 6-8, the present brake temperature detector is applied to the drum brake system 2. The connector 12 on the end part of the temperature sensor wire 11 includes a mounting base 123 and a sensing piece 124. One end of the mounting base 123 is connected to the temperature sensor wire 11 correspondingly while the other end of the mounting base 123 is inserted by and contacted with the sensing piece 124. The sensing piece 124 is fixed between the lining 21 and the back board 26. When the brake system 2 operates, the piston is pushed by oil pressure so that heat generated due to the lining 21 clipped the brake disc 24 can be transferred through the sensing piece 124 and the mounting base 123. And the brake temperature signals are transmitted to the signal transmitter 3 through the temperature sensor wire 11. Each of the signal transmitters 3 gets power from a built-in power supply unit 31 which is a rechargeable battery and then transmits the brake temperature signals to the display unit 4 in a wireless manner. Then values of the brake temperature and power status sensed by the plurality of the temperature sensing modules 1 are shown on the display unit 4, as shown in FIG. 12. The display unit 4 consists of a warning light 41 for generating warning light signals and an alarm unit 42 for creating warning sounds. When the brake temperature is too high (over a set value) or abnormal, drivers are reminded about the brake temperature by the warning light 41 and the alarm unit 42 to ensure driving safety.

### Embodiment Four

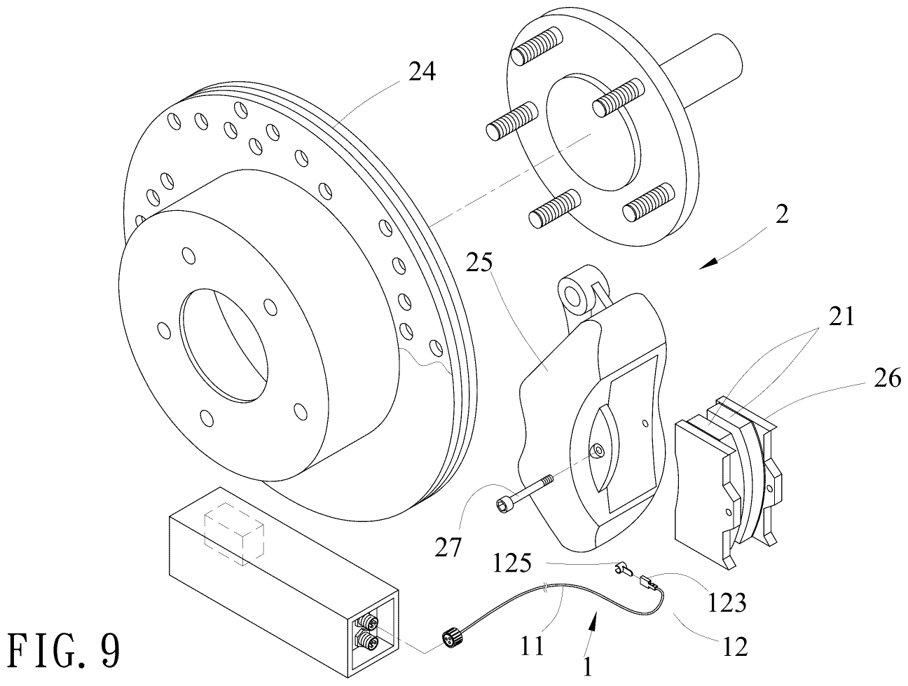

Refer to the fourth embodiment shown in FIGS. 9-11, the present brake temperature detector is applied to the drum brake system 2 and the connector 12 on the end part of the temperature sensor wire 11 is provided with a mounting base 123 and a clip 125 (able to be C-shaped). One end of the mounting base 123 is connected to the temperature sensor wire 11 correspondingly while the other end of the mounting base 123 is inserted by and contacted with the clip 125. The clip 125 is clipped and fixed on the shaft 27 used for connecting the back board 26 having the lining 21 with the brake caliper 25. When the brake system 2 works, the piston is pushed by oil pressure so that heat generated due to the lining 21 clipped the brake disc 24 can be transferred through the clip 125 and the mounting base 123. And the brake temperature signals are transmitted to the signal transmitter 3 through the temperature sensor wire 11. Each of the signal transmitters 3 gets power from a built-in power supply unit 31 which is a rechargeable battery and then transmits the brake temperature signals to the display unit 4 wirelessly. Then values of the brake temperature and power status sensed by the plurality of the temperature sensing modules 1 are shown on the display unit 4, as shown in FIG. 12. The display unit 4 consists of a warning light 41 for generating warning light signals and an alarm unit 42 for creating warning sounds. When the brake temperature is too high (over a set value) or abnormal, drivers are reminded about the brake temperature by the warning light 41 and the alarm unit 42 to ensure driving safety.

Compared with the brake temperature detector available now, the present invention has the following advantages.

1. The drivers can learn working temperature and data of the brake system according to temperature changes caused by high speed friction in the brake system sensed. Thus they can make early response to prevent the brake system from overheating and further avoid brake failure. Thereby driving safety is ensured.

2. Abnormal brake conditions can be found out earlier by the present device using the temperature changes. The brake overheating which leads to brake failure can also be avoided by monitoring of the brake temperature. For example, part failure or brake drag can result in excessive friction and high temperature of the brake system. The high temperature of the brake system is transmitted to tires so that the tires blow out and even worse the brake system catches fire to induce a vehicle fire. Moreover, to apply the brake system too much may cause the braking system temperature too high and further result in brake failure.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A brake temperature detector comprising:
a plurality temperature sensing modules each of which includes a temperature sensor wire and a connector; wherein the connector is disposed on an end part of the temperature sensor wire and mounted in a brake system of vehicles for transmitting temperature of the brake system through the temperature sensor wire;
at least one signal transmitter connected to the temperature sensor wire correspondingly to receive the temperature of the brake system detected by the temperature sensing module and transmit signals related to the temperature of the brake system in a wireless way; and
a display unit used to receive the signals related to the temperature of the brake system from the signal transmitter wirelessly and show values of the temperature of the brake system detected by the plurality of the temperature sensing modules.

2. The detector as claimed in claim 1, wherein a drum brake system is used as the brake system and provided with a plurality of brake shoes each of which is fitted with a brake lining and pivotally mounted to a brake rotor by a threaded part inserted through the brake shoe; the connector on the end part of the temperature sensor wire is provided with a ring portion which is mounted on the threaded part of a brake shoe correspondingly.

3. The detector as claimed in claim 1, wherein a drum brake system is used as the brake system and provided with a plurality of brake shoes each of which is fitted with a brake lining and pivotally mounted to a brake rotor by a threaded part inserted through the brake shoe; the connector on the end part of the temperature sensor wire is provided with a U-shaped portion which is mounted to and inserted in the threaded part of the brake shoe correspondingly.

4. The detector as claimed in claim 1, wherein the disc brake system is used as the brake system; the disc brake system includes a brake disc, a brake caliper, and linings; the brake caliper is a component attached and mounted to a front or a rear side of the brake disc and the lining is a wear resistant part in contact with the brake disc for having friction and generating braking power; the linings are connected to a back board and mounted in the brake caliper by a shaft inserted through the back board; wherein the connector on the end part of the temperature sensor wire includes a mounting base and a sensing piece; one end of the mounting base is connected to the temperature sensor wire correspondingly while the other end of the mounting base is inserted by and contacted with the sensing piece; the sensing piece is fixed between the lining and the back board.

5. The detector as claimed in claim 1, wherein the disc brake system is used as the brake system; the disc brake system includes a brake disc, a brake caliper, and linings; the brake caliper is a component attached and mounted to a front or a rear side of the brake disc and the lining is a wear resistant part in contact with the brake disc for having friction and generating braking power; the linings are connected to a back board and mounted in the brake caliper by a shaft inserted through the back board; wherein the connector on the end part of the temperature sensor wire includes a mounting base and a clip; one end of the mounting base is connected to the temperature sensor wire correspondingly while the other end of the mounting base is inserted by and contacted with the clip; the clip is clipped and fixed on the shaft used for connecting the back board having the linings with the brake caliper.

6. The detector as claimed in claim 4, wherein the clip is a C-shaped clip.

7. The detector as claimed in claim 1, wherein the display unit is provided with at least one warning light for generating warning light signals and at least one alarm unit for creating warning sounds.

8. The detector as claimed in claim 1, wherein the signal transmitter is provided with a power supply unit used for providing power required to the signal transmitter.

9. The detector as claimed in claim 8, wherein the power supply unit is a rechargeable battery.
